(19) United States
(12) Patent Application Publication
(10) Pub. No.: US 2016/0025035 A1
(43) Pub. Date: Jan. 28, 2016

(54) HEAT-INSULATING LAYER ON SURFACE OF COMPONENT AND METHOD FOR FABRICATING SAME

(71) Applicant: MAZDA MOTOR CORPORATION, Hiroshima (JP)

(72) Inventors: Shinji KADOSHIMA, Hiroshima-shi (JP); Satoshi NANBA, Hiroshima-shi (JP); Nobuo SAKATE, Akigun (JP); Hirofumi INOUE, Hadano-shi (JP)

(73) Assignee: MAZDA MOTOR CORPORATION, Hiroshima (JP)

(21) Appl. No.: 14/431,144

(22) PCT Filed: Sep. 4, 2014
(86) PCT No.: PCT/JP2014/004552

§ 371 Date: Mar. 25, 2015

(30) Foreign Application Priority Data
Sep. 30, 2013 (JP) 2013-204919

(51) Int. Cl. F02F 3/14; F01L 1/46; F02F 1/24; C23D 5/02; F02F 1/00

(52) U.S. Cl. CPC F02F 3/14; C23D 5/02; F02F 1/004; F02F 1/24; F01L 1/46

(57) ABSTRACT

A heat-insulating layer (21) provided on a surface of a component (19) facing an engine combustion chamber contains hollow particles (23) made of an inorganic oxide, a filler material (25), and a vitreous material (27) containing silicic acid as a main constituent. The vitreous material (27) is not in powder form, and surrounds and bonds the hollow particles (23) and the filler material (25) together.

### TECHNICAL FIELD

The present invention relates to a heat-insulating layer provided on a surface of a component, and a method for fabricating the heat-insulating layer.

### BACKGROUND ART

In 1980s, providing a heat-insulating layer at a portion facing the engine combustion chamber was suggested as a method for increasing the heat efficiency of the engine. Thereafter, a heat-insulating layer made of ceramics sintered compact, or a heat-insulating layer made of a thermal sprayed layer containing zirconia (ZrO₂) particles having a low thermal conductivity has been suggested.

However, the ceramics sintered compact may be cracked due to thermal stress and thermal shock, and be separated due to development of the cracks. The heat-insulating layers made of ceramics sintered compact have therefore not been applied for practical use, particularly to relatively large areas of parts, such as the top face of a piston, the inner circumferential surface of a cylinder liner, and the bottom face of a cylinder head.

On the other hand, the sprayed layers have been adopted for use on the inner surface of the cylinder liner and the trochoid surface of the rotary engine. However, they are intended to improve the wear resistance, and not intended to improve the heat resistance. In order to use the sprayed layer as the heat-insulating layer, it is preferred to spray low thermal conductivity material containing ZrO₂ as a main constituent, as described above.

For example, Patent Document 1 discloses forming projections and depressions in a surface of an engine part facing the combustion chamber, and filling, by spraying, the depressions with low thermal conductivity material containing ZrO₂ as a main constituent. Further, Patent Document 2 discloses an internal-combustion engine provided with a heat-insulating film that includes a plurality of first heat-insulating materials formed into particles, a second heat-insulating material formed into a film, and reinforcing fibers. Patent Document 2 also discloses that examples of the second heat-insulating material may include ceramics, such as zirconia (ZrO₂), silicon, titanium, or zirconium, ceramics containing carbon and oxygen as a main component, or high-strength and high-heat resistance ceramic fibers, and may further include a combination of these materials.

### CITATION LIST

### Patent Document

Patent Document 1: Japanese Unexamined Patent Publication No. 2005-146925

Patent Document 2: Japanese Unexamined Patent Publication No. 2009-243352

### SUMMARY OF THE INVENTION

### Technical Problem

However, the sprayed layer in Patent Document 1 and the heat-insulating material, e.g., ceramics, in Patent Document 2 are made of particles (powders) bonded together, and therefore have a gap between the particles, that is, they are porous. For this reason, in a so-called direct-injection engine, in which fuel is directly injected into the combustion chamber, the injected fuel reaches the piston surface and enters into the heat-insulating layer through the gap. As a result, the fuel cannot contribute to combustion. Further, if the fuel having entered into the heat-insulating layer gradually turns into carbon and remains as carbon deposits, it may increase a thermal conductivity of the heat-insulating layer, and may lead to a reduction in performance.

In recent years, homogeneous-charge compression ignition (HCCI) combustion in a direct-injection gasoline engine has gained attention and is being developed as a combustion system that improves the fuel efficiency of the engine. However, since the combustion temperature of HCCI is low, reducing cooling loss from the engine combustion chamber and thereby improving the heat efficiency are demanded. Thus, providing a heat-insulating layer having high heat insulation property onto surfaces of, e.g., a piston, a cylinder head, a valve and a cylinder liner, which face the engine combustion chamber is demanded.

The present invention was made to solve the above problems, and is intended to provide a heat-insulating layer which, when provided, for example, on a component facing the engine combustion chamber, can prevent fuel from entering into the heat-insulating layer, maintain high heat-insulating property for a long period of time, and improve the heat efficiency of the engine.

### Solution to the Problem

To achieve the above objective, in the present invention, a vitreous material that is not in powder form was used as a material for a heat-insulating layer on a surface of a component.

Specifically, a heat-insulating layer on a surface of a component according to the present invention includes: hollow particles made of an inorganic oxide; a filler material; and a vitreous material containing silicic acid as a main constituent, wherein the vitreous material is not in powder form, and surrounds and bonds the hollow particles and the filler material together.

According to the heat-insulating layer on the surface of the component of the present invention, the vitreous material surrounds the hollow particles and the filler material and bonds them together. It is therefore possible to create a state where the gap between the hollow particles and the gap between the hollow particles and the filler material are filled. Moreover, the vitreous material is not in powder form, and is dense in texture unlike the porous sprayed layer and ceramic layer made of e.g., zirconia. Thus, for example, if the heat-insulating layer is provided on a component surface facing the engine combustion chamber, the fuel injected in the engine combustion chamber can be prevented from entering in the heat-insulating layer. As a result, generation of carbon deposits due to the fuel having entered in the heat-insulating layer can be avoided, and the heat insulation property is prevented from decreasing. The heat efficiency of the engine can therefore be improved.

In the heat-insulating layer on the surface of the component according to the present invention, volume ratios (vol %) of the hollow particles, the filler material, and the vitreous material are preferably in the following ranges: hollow particles:filler material:vitreous material=40 to 75:1 to 5:23 to 58.

This means that the volume ratio of the hollow particles as a constituent of the heat-insulating layer is large, and it is possible to contain a large amount of air in the heat-insulating layer. It is thus possible to reduce the thermal conductivity of the heat-insulating layer and improve the heat insulation property of the heat-insulating layer. Further, setting the volume ratio of the hollow particles in the heat-insulating layer to 75 vol % or less makes it possible to ensure a sufficient amount of the vitreous material, which bonds between the hollow particles, and therefore possible to form a durable film.

If quantitative ratios of the hollow particles, the filler material, and the vitreous material are expressed by mass ratio (mass %), not by volume ratio (vol %), it is preferred that the mass ratio of the vitreous material is the highest, and that the mass ratios of the hollow particles, the filler material, and the vitreous material are in the following ranges: hollow particles:filler material:vitreous material=17 to 48:5 to 14:44 to 75.

Similarly to the above description, this makes it possible to reduce the thermal conductivity of the heat-insulating layer, and improve the heat insulation property of the heat-insulating layer. At the same time, it becomes possible to ensure a sufficient amount of the vitreous material, and form a durable film.

The thermal conductivity of the heat-insulating layer on the surface of the component according to the present invention is preferably in a range of 0.15 W/m·K or more and 0.4 W/m·K or less.

Further, the volume specific heat of the heat-insulating layer on the surface of the component according to the present invention is preferably in a range of 400 kJ/m³·K or more and 1300 kJ/m³·K or less.

If such a heat-insulating layer having a low thermal conductivity or a low volume specific heat as described above is provided on a surface of a component facing the engine combustion chamber, heat loss in the combustion chamber can be reduced more. In addition, the heat-insulating layer having a low volume specific heat solves a problem that an intake filling amount is reduced in the intake stroke of the engine, because the temperature of such a heat-insulating layer is decreased by the intake air. The heat efficiency is therefore improved.

In the heat-insulating layer on the surface of the component according to the present invention, it is preferred that the hollow particles contain at least one of silica or alumina as a main component, and that a median diameter of the hollow particles is 5 μm or more and 30 μm or less.

If the median diameter of the hollow particle is 5 μm or more, a greater amount of air can be contained in the particle, whereas if the median diameter of the hollow particle is 30 μm or less, more particles can be contained in the heat-insulating layer with respect to the height of the heat-insulating layer. This makes it possible to obtain a necessary amount of air for high insulation property. Moreover, if the median diameter of the hollow particles is 30 μm or less, it is possible to reduce the surface roughness of the heat-insulating layer. If this heat-insulating layer is provided, for example, on a surface of a component facing the engine combustion chamber, it is possible to prevent a local increase of the surface temperature of the heat-insulating layer, and prevent abnormal combustion in the engine and heat damage of the heat-insulating layer.

In the heat-insulating layer on the surface of the component according to the present invention, the filler material may be made of at least one of a fibrous inorganic oxide or a transition metal oxide.

The fibrous inorganic oxide increases the strength of the heat-insulating layer and reduces generation of cracks. The transition metal oxide contributes to an increase in hardness of the heat-insulating layer.

A method for fabricating a heat-insulating layer on a surface of a component according to the present invention includes the steps of: preparing a component on which the heat-insulating layer is formed; mixing a solution which contains a precursor to be a vitreous material by a heat treatment, and hollow particles and a filler material; applying a mixture obtained by the mixing to the surface of the component; and turning the precursor into the vitreous material by performing heat treatment on the applied mixture at 90° C. or more and 160° C. or less for 40 minutes or less.

According to the method for fabricating the heat-insulating layer on the surface of the component of the present invention, it is possible to form, on the surface of the component, the heat-insulating layer containing the hollow particles, the filler material, and the vitreous material containing silicic acid as a main constituent. In the obtained heat-insulating layer, a mixed solution in which the precursor solution, the hollow particles, and the filler material are mixed together is subjected to heat treatment, thereby turning the precursor into the vitreous material. Thus, the vitreous material surrounds the hollow particles and the filler material, and bonds them together. As a result, it is possible to create a state where the gap between the hollow particles and the gap between the hollow particles and the filler material are filled with the vitreous material. Further, in the obtained heat-insulating layer, the vitreous material is obtained by heating and hardening its precursor solution. That is, the vitreous material is not in powder form, and is dense in texture. Thus, for example, if the heat-insulating layer is provided on a surface of a component facing the engine combustion chamber, it is possible to prevent fuel from entering into the heat-insulating layer. This makes it possible to avoid generation of carbon deposits due to the fuel having entered in the heat-insulating layer, and prevent a reduction in heat insulation property. Thus, a heat-insulating layer which can improve the heat efficiency of the engine can be obtained.

The method for fabricating the heat-insulating layer on the surface of the component according to the present invention, silicon alkoxide may be used as the precursor.

### Advantages of the Invention

A heat-insulating layer on a surface of a component according to the present invention can, when provided, for example, on a component surface facing an engine combustion chamber, prevent fuel from entering into the heat-insulating layer, maintain high heat-insulating property for a long period of time, and thus improve the heat efficiency of the engine. Further, such a heat-insulating layer which has the above advantages can be obtained by the method of the present invention for fabricating the heat-insulating layer on a surface of a component.

### BRIEF DESCRIPTION OF THE DRAWINGS

FIG. 1 is a cross-sectional view of an engine structure according to an embodiment of the present invention.

FIG. 2 is a cross-sectional view of a heat-insulating layer on a component surface facing an engine combustion chamber according to an embodiment of the present invention.

FIG. 3 is an enlarged cross-sectional view of a heat-insulating layer on a component surface facing an engine combustion chamber according to an embodiment of the present invention.

FIG. 4 is a flow chart showing a method for fabricating a heat-insulating layer on a component surface facing an engine combustion chamber according to an embodiment of the present invention.

FIG. 5 is a graph showing a relationship between a content ratio of hollow particles in a heat-insulating layer, and a thermal conductivity and a volume specific heat of the heat-insulating layer.

### DESCRIPTION OF EMBODIMENT

An embodiment for implementing the present invention will be described below, based on the drawings. The following embodiment is merely a preferred example in nature, and is not intended to limit the scope, applications, and use of the invention.

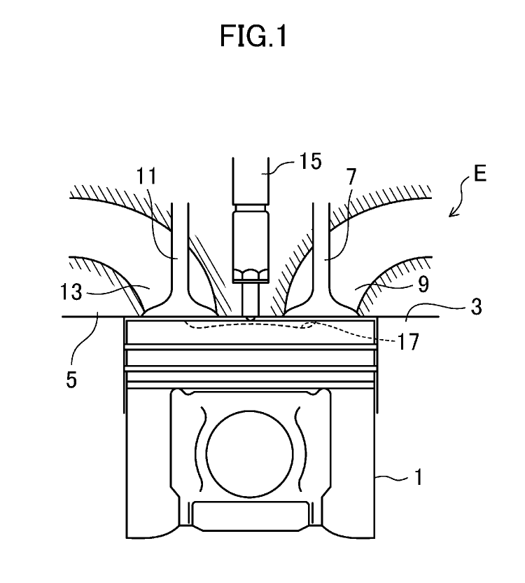

In the present embodiment, the present invention is adopted to a component facing the combustion chamber of the engine shown in FIG. 1.

<Features of Engine>

Of the direct-injection engine E shown in FIG. 1, the reference character 1 is a piston; the reference character 3 is a cylinder block; the reference character 5 is a cylinder head; the reference character 7 is an intake valve for opening/closing an intake port 9 of the cylinder head 5; the reference character 11 is an exhaust valve for opening/closing an exhaust port 13; and the reference character 15 is a fuel injection nozzle. The combustion chamber of the engine is defined by the top face of the piston 1, the cylinder block 3, the cylinder head 5, and the valve head surfaces (i.e., surfaces facing the combustion chamber) of the intake and exhaust valves 7 and 11. A cavity 17 is formed in the top face of the piston 1. A spark plug and a cylinder liner are omitted in the drawing.

It is known that, in theory, the higher the geometric compression ratio is, and the higher the excess air ratio of the working medium is, the higher the heat efficiency of the engine becomes. However, in reality, the improvement in heat efficiency due to the increase in the compression ratio and the excess air ratio has an upper limit because the higher the compression ratio is, and the higher the excess air ratio is, the more the cooling loss increases.

That is, the cooling loss depends on a coefficient of heat transfer from the working medium to the engine combustion chamber wall, the area of the heat transfer, and a temperature difference between the gas temperature and the wall temperature. Thus, in the engine combustion chamber, a heat-insulating layer whose thermal conductivity is lower than that of the metallic base material of engine parts, is formed on the surface of the metallic base material.

<Structure of Heat-Insulating Layer>

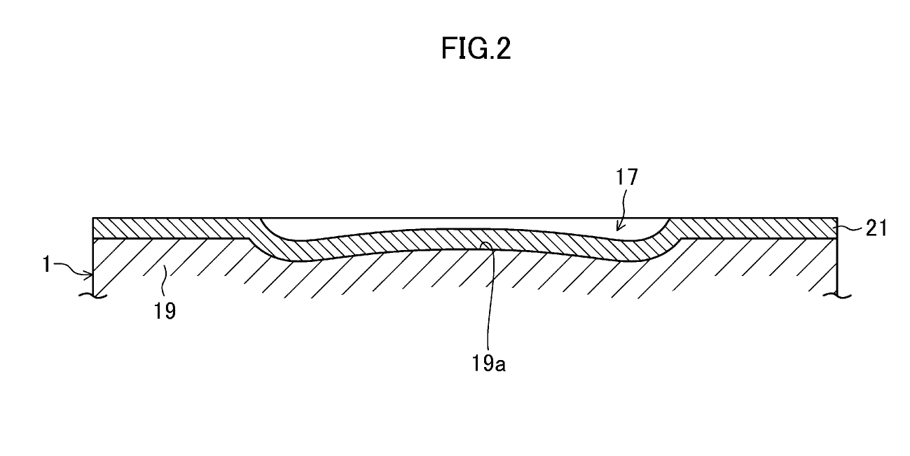

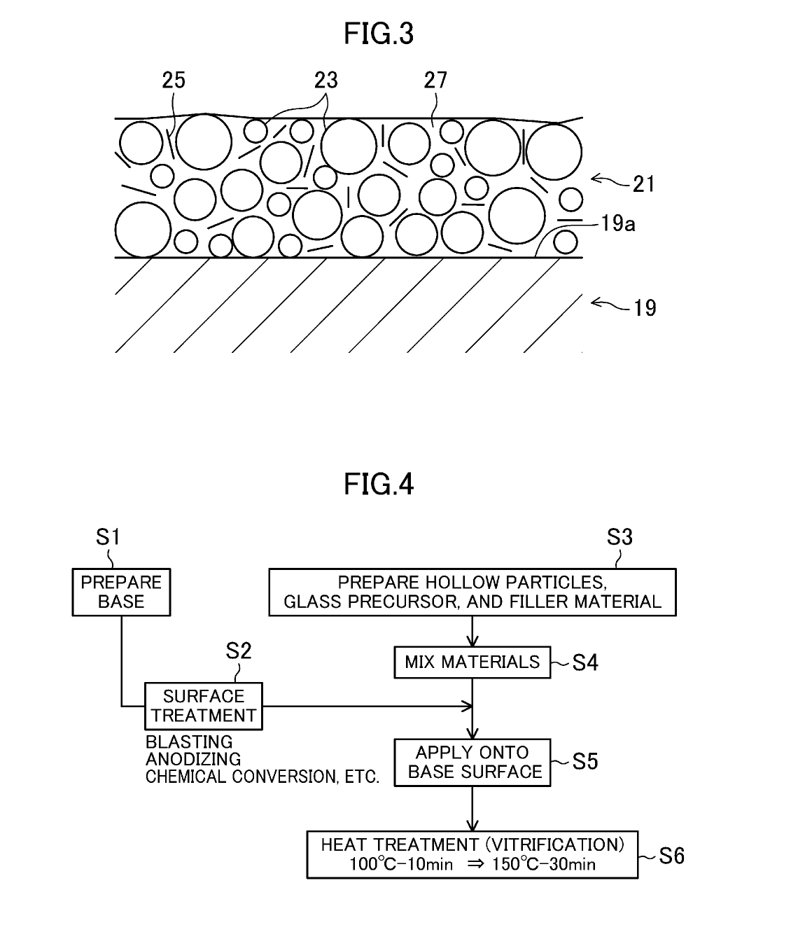

Now, the structure of the heat-insulating layer provided on the component surface facing the engine combustion chamber will be described with reference to FIG. 2 and FIG. 3. In the present embodiment, a heat-insulating layer provided on the top face of the piston, as a surface of a component facing the engine combustion chamber, will be explained. However, a heat-insulating layer provided on a surface of another component (e.g., a cylinder block) facing the engine combustion chamber may also have the same structure.

As shown in FIG. 2, a heat-insulating layer 21 is provided on the top face 19a of a piston body 19 that is an engine component (i.e., on a surface of a component facing the engine combustion chamber). A recessed portion, which corresponds to the cavity 17, is formed at a central portion of the top face 19a of the piston body 19. The heat-insulating layer 21 has a uniform thickness, following the shape of the top face 19a. The piston body 19 of the present embodiment is made of an aluminum alloy with a T6 temper. Further, the top face 19a of the piston body 19, on which the heat-insulating layer 21 is provided, is subjected to a surface roughening process, such as a blasting process and an anodizing treatment (an alumite treatment). Projections and depressions are thus formed in the top face 19a of the piston body 19, enabling an improvement in adhesiveness between the piston body 19 and the heat-insulating layer 21. As a result, the heat-insulating layer 21 is prevented from being separated from the piston body 19. Other techniques may be used as long as they are processes for improving the adhesiveness between the piston body 19 and the heat-insulating layer 21. For example, the top face 19a of the piston body 19 may be subjected to a chemical conversion process.

As illustrated in FIG. 3, the heat-insulating layer 21 of the present embodiment contains hollow particles 23 of an inorganic oxide, a filler material 25, and a vitreous material 27 having silicic acid as a main constituent. The layer structure of the heat-insulating layer 21 is formed by the vitreous material 27 that surrounds the hollow particles 23 and the filler material 25 and bonds them together. The vitreous material 27 bonds between the hollow particles 23 and between the hollow particles 23 and the filler material 25 by filling the gap therebetween. Further, the vitreous material 27 is not in powder form, and is dense in texture. This does not allow a gap, through which the fuel pass, to exist between the hollow particles 23 and in the vitreous material 27 itself, and as a result, it is possible to prevent the fuel injected into the engine combustion chamber from entering in the heat-insulating layer 21.

In the present embodiment, it is preferable to use ceramic based hollow particles, such as fly ash balloons, Shirasu balloons, silica balloons, and aerogel balloons, which contain an Si-based oxide component (e.g., silica (SiO₂)) or an Al-based oxide component (e.g., alumina (Al₂O₃)). The material and the particle size of each balloon are shown in Table 1.

TABLE 1

| Hollow Particle Type | Material | Particle Size (μm) |
|---|---|---|
| Fly Ash Balloon | SiO₂, Al₂O₃ | 1-300 |
| Shirasu Balloon | SiO₂, Al₂O₃ | 5-600 |
| Silica Balloon | SiO₂, Al₂O₃ | 0.09-0.11 |
| Aerogel Balloon | SiO₂ | 0.02-0.05 |

For example, the chemical composition of the fly ash balloon is as follows: 40.1 to 74.4 mass % of SiO₂; 15.7 to 35.2 mass % of Al₂O₃; 1.4 to 17.5 mass % of Fe₂O₃; 0.2 to 7.4 mass % of MgO; and 0.3 to 10.1 mass % of CaO. The chemical composition of the Shirasu balloon is as follows: 75 to 77 mass % of SiO₂; 12 to 14 mass % of Al₂O₃; 1 to 2 mass % of Fe₂O₃; 3 to 4 mass % of Na₂O; 2 to 4 mass % of K₂O; and 2 to 5 mass % of IgLoss. The median diameter (D50) of the hollow particle 23 is preferably 5 μm or more and 30 μm or less. If the median diameter of the hollow particle is 5 μm or more, a greater amount of air can be contained in the particle, whereas if the median diameter of the hollow particle is 30 μm or less, more particles can be contained in the heat-insulating layer with respect to the height of the heat-insulating layer. This makes it possible to obtain a necessary amount of air for high insulation property. Moreover, if the median diameter of the hollow particles is 30 μm or less, it is possible to reduce the surface roughness of the heat-insulating layer, prevent a local increase of the surface temperature, and prevent abnormal combustion in the engine and heat damage of the heat-insulating layer.

It is preferable that the heat-insulating layer 21 contains such hollow particles 23 at a volume ratio of 40 vol % or more and 75 vol % or less. Further, it is preferable that the heat-insulating layer 21 contains the hollow particles 23 at a mass ratio of 17 mass % or more and 48 mass % or less. In this composition, the content of the hollow particles 23 as a component of the heat-insulating layer 21 is large, i.e., 40 vol % or more or 17 mass % or more. This means that a large amount of air can be contained in the heat-insulating layer 21. As a result, the thermal conductivity and the volume specific of the heat the heat-insulating layer 21 can be reduced, and the heat insulation property of the heat-insulating layer 21 can be improved. Further, setting the volume ratio of the hollow particles 23 in the heat-insulating layer 21 to 75 vol % or less, or the mass ratio to 48 mass % or less, makes it possible to ensure a sufficient amount of the vitreous material 27, which bonds between the hollow particles 23, and therefore possible to form a durable film. It is preferable to obtain the heat-insulating layer 21 with a low thermal conductivity of about 0.15 W/m·K or more and 0.4 W/m·K or less, or with a low volume specific heat of about 400 kJ/m³·K or more and 1300 kJ/m³·K or less, by adjusting the content of the hollow particles 23 in the heat-insulating layer 21, as mentioned above. The relationship between the content of the hollow particles 23 in the heat-insulating layer 21 and the thermal conductivity and volume specific of the heat heat-insulating layer 21 will be described in detail later.

In the case where the heat-insulating layer 21 contains the hollow particles 23 in the above range, it is preferable that the filler material 25 is contained in the heat-insulating layer 21 at a volume ratio of 1 vol % or more and 5 vol % or less, and that the vitreous material 27 is contained in the heat-insulating layer 21 at a volume ratio of 23 vol % or more and 58 vol % or less. Further, it is preferable that the filler material 25 is contained in the heat-insulating layer 21 at a mass ratio of 5 mass % or more and 14 mass % or less, and that the vitreous material 27 is contained in the heat-insulating layer 21 at a mass ratio of 44 mass % or more and 75 mass % or less. The filler material 25 is contained in the heat-insulating layer 21 to reinforce the heat-insulating layer 21, and preferably made of high-strength and high-heat resistance materials. For example, fibrous inorganic oxides and transition metal oxides may be favorably used. Further, the vitreous material 27 is used to bond between the hollow particles 23 and between the hollow particles 23 and the filler material 25, thereby forming the heat-insulating layer 21. If the content of the vitreous material 27 in the heat-insulating layer 21 is 23 vol % or more or 44 mass % or more, it allows the hollow particles 23, and the hollow particles 23 and the filler material 25 to be sufficiently bonded together, and it is possible to form a durable film. Further, setting the volume ratio of the vitreous material 27 in the heat-insulating layer 21 to 58 vol % or less or 75 mass % or less makes it possible to ensure a sufficient amount of the hollow particles 23, which increase the heat insulation property, and therefore possible to obtain the heat-insulating layer 21 with high heat-insulating property.

<Method for Fabricating Heat-Insulating Layer>

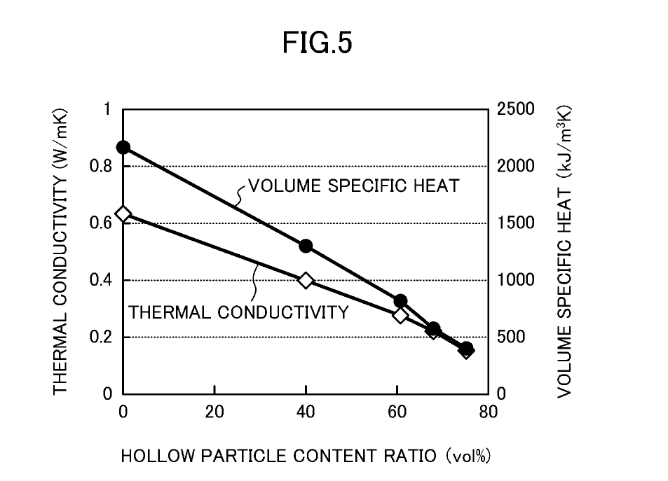

Now, a method for providing the above-described heat-insulating layer on the top face of the piston as a component surface facing the engine combustion chamber, will be explained with reference to FIG. 4. Although a method for providing the heat-insulating layer on the top face of the piston body will be explained in the following description, the heat-insulating layer may be provided on other engine components, e.g., a cylinder block, by the same method as used in providing the heat-insulating layer on the piston body.

First, a piston body (a base) made of an aluminum alloy, which is an engine component, is prepared (Step S1). The piston body is degreased to remove grease and fingerprints adhering on the surface where the heat-insulating layer is to be provided. Further, the top face of the piston body is preferably subjected to a surface roughening process (surface treatment) to increase adhesiveness between the piston body and the heat-insulating layer (Step S2). For example, a blasting process (e.g., sandblasting) is preferred as the surface treatment. For example, the blasting process may be performed by an air blast machine, using particle size #30 alumina as a projection material, under the process conditions of the pressure of 0.39 MPa, time of 45 seconds, and distance of 100 mm Alternatively, an alumite treatment may be performed to improve adhesiveness between the piston body and the heat-insulating layer. For example, the alumite treatment may be performed in an oxalic acid bath under process conditions of a bath temperature of 20° C., electric current density of 2 A/dm², and time of 20 minutes. The surface treatment is not limited to thereto, and a chemical conversion process may be adopted, for example.

Hollow particles, a filler material, and a precursor solution of the vitreous material are prepared as materials for the heat-insulating layer (Step S3). For example, the above-mentioned Shirasu balloons and silica balloons can be used as the hollow particles. Fibrous inorganic oxides, transition metal oxides, etc., may be used as the filler material. Specifically, potassium titanate fibers may be favorably used. Any material which can turn into a vitreous material containing silicic acid as a main constituent by heat treatment may be used as the precursor. For example, a silicon alkoxide solution (e.g., G-90 manufactured by izumo inc.) can be used as the precursor. After the preparation of the above materials, the materials are stirred and mixed to prepare a mixed solution (Step S4).

After preparing the piston body in the above described manner, and preparing the mixed solution in which the above materials are mixed, the mixed solution is applied to the top face of the piston body by spraying or spin coating, or with a brush (Step S5).

After that, heat treatment is performed on the applied mixed solution to cure the precursor to be the vitreous material (Step S6). The heat treatment is performed on the applied mixture at 90° C. or more and 160° C. or less for 40 minutes or less. The conditions of the heat treatment can be appropriately adjusted within the above ranges, depending on the material of the precursor. For example, in the case of using G-90 manufactured by izumo inc., heat treatment at about 100° C. for about 10 minutes is performed first to remove a solvent and water from the mixed solution and dry the mixed solution, and thereafter heat treatment at about 150° C. for about 30 minutes is performed to cure the precursor to be a vitreous material containing silicic acid as a main constituent.

The heat-insulating layer containing the hollow particles, the filler material, and the vitreous material can be formed on the top face of the piston body, that is, on a component surface facing the engine combustion chamber, in the above-described manner. In the thus formed heat-insulating layer, the vitreous material is obtained by vitrifying the precursor solution, and is not in powder form. The vitreous material bonds between the hollow particles and between the hollow particles and the filler material by filling the gap therebetween. Thus, the heat-insulating layer is not porous, and the fuel can be prevented from entering in the heat-insulating layer. As a result, the heat-insulating property can be maintained for a long period of time, and the heat efficiency of the engine can be accordingly improved.

<Performance Test for Heat-Insulating Layer>

Results of studying a relationship between a content ratio of the hollow particles in the heat-insulating layer obtained by the above fabrication method according to the present embodiment and provided on the component surface facing the engine combustion chamber, and the thermal conductivity and the volume specific heat of the heat-insulating layer, will be explained below. Heat-insulating layers in which the hollow particles were contained at different content ratios that vary between 0 vol % and 75 vol % were formed, and the thermal conductivity and volume specific heat of the respective heat-insulating layers were compared between the heat-insulating layers in terms of the differences between the amounts of the hollow particles. Specifically, five types of heat-insulating layers containing the hollow particles at 0 vol %, 40 vol %, 60.7 vol %, 67.8 vol % or 75 vol % were formed. The content ratio between the filler material and the vitreous material was controlled to be constant, i.e., the filler material:vitreous material=7:93 (volume ratio), in the rest of the heat-insulating layer excluding the hollow particles.

The heat-insulating layers were obtained in the above-described fabrication method, using the above-described Shirasu balloons as the hollow particles, potassium titanate fibers as the filler material, and G-90 made of silicon alkoxide and manufactured by izumo inc. as the precursor. The heat-insulating layer was formed on a base made of aluminum alloy.

The thermal diffusivity (m²/s), the density (kg/m³), and the weight specific heat (kJ/kg·K) of the respective obtained heat-insulating layers were measured. They were measured by ordinary methods. Specifically, the thermal diffusivity was measured by laser flash method; the density was measured by the Archimedes method; and the weight specific heat was measured by differential scanning calorimetry (DSC). The measurements were performed under a condition of 25° C. The volume specific heat and the thermal conductivity were calculated by the following equations, respectively, based on the results of the measurements: volume specific heat (kJ/m³·K)=density×thermal diffusivity; and thermal conductivity (W/m·K)=thermal diffusivity×density×weight specific heat. The results are shown in FIG. 5.

As shown in FIG. 5, the thermal conductivity and the volume specific heat of the heat-insulating layer decrease as the content ratio of the hollow particles in the heat-insulating layer increases. Specifically, in the case where the heat-insulating layer does not contain hollow particles (0 vol %), the thermal conductivity was 0.63 W/m·K, and the volume specific heat was 2159 kJ/m³·K, whereas in the case where the content ratio of the hollow particles is increased to 40 vol %, the thermal conductivity was 0.4 W/m·K, and the volume specific heat was reduced to 1300 kJ/m³·K. Further, in the case where the content ratio of the hollow particles in the heat-insulating layer is increased to 75 vol %, the thermal conductivity was 0.15 W/m·K, and the volume specific heat was reduced to 400 kJ/m³·K.

Further, a heat-insulating layer (having a thickness of about 75 μm) containing the hollow particles at 60.7 vol % was formed on the top face of a piston, and the piston was incorporated in a mass-produced gasoline engine to make an endurance test in a high-speed acceleration and deceleration mode. The result was that separation of the heat-insulating layer was not found, and it was confirmed that endurance reliability was high.

This shows that, according to the present invention, it is possible to provide a heat-insulating layer whose thermal conductivity and volume specific heat are low, whose heat insulation property is high, and whose durability is high, by containing the hollow particles in the heat-insulating layer.

The present invention is applicable to the formation of a heat-insulating layer not only on components facing the combustion chamber of an engine, but also on surfaces of various types of components for industrial use or consumer use.

### DESCRIPTION OF REFERENCE CHARACTERS

1 piston

3 cylinder block

5 cylinder head

7 intake valve

11 exhaust valve

19 piston body

19a top face

21 heat-insulating layer

23 hollow particles

25 filler material

27 vitreous material

1. A heat-insulating layer provided on a surface of a component, the heat-insulating layer includes:
hollow particles made of an inorganic oxide;
a filler material; and
a vitreous material containing silicic acid as a main constituent, wherein
the vitreous material is not in powder form, and surrounds and bonds the hollow particles and the filler material together.

2. The heat-insulating layer of claim 1, wherein
volume ratios (vol %) of the hollow particles, the filler material, and the vitreous material are in the following ranges:
hollow particles:filler material:vitreous material=40 to 75:1 to 5:23 to 58.

3. The heat-insulating layer of claim 1, wherein
among mass ratios (mass %) of the hollow particles, the filler material, and the vitreous material, the mass ratio of the vitreous material is the highest, and
the mass ratios of the hollow particles, the filler material, and the vitreous material are in the following ranges:
hollow particles:filler material:vitreous material=17 to 48:5 to 14:44 to 75.

4. The heat-insulating layer of claim 2, wherein
a thermal conductivity of the heat-insulating layer is in a range of 0.15 W/m·K or more and 0.4 W/m·K or less.

5. The heat-insulating layer of claim 2, wherein
a volume specific heat of the heat-insulating layer is in a range of 400 kJ/m³·K or more and 1300 kJ/m³·K or less.

6. The heat-insulating layer of claim 1, wherein
the hollow particles contain at least one of silica or alumina as a main component, and a median diameter of the hollow particles is 5 μm or more and 30 μm or less.

7. The heat-insulating layer of claim 1, wherein
the filler material is made of at least one of a fibrous inorganic oxide or a transition metal oxide.

8. The heat-insulating layer of claim 1, wherein
the component is an engine component facing an engine combustion chamber.

9. A method for fabricating a heat-insulating layer on a surface of a component, the method comprising the steps of:
preparing a component on which the heat-insulating layer is formed;
mixing a solution which contains a precursor to be a vitreous material by a heat treatment, and hollow particles and a filler material;
applying a mixture obtained by the mixing to the surface of the component; and
turning the precursor into the vitreous material by performing heat treatment on the applied mixture at 90° C. or more and 160° C. or less for 40 minutes or less.

10. The method for claim 9, wherein
silicon alkoxide is used as the precursor.

11. The method for claim 9, wherein
the component is an engine component facing an engine combustion chamber.
